(19) United States
(12) Patent Application Publication
(10) Pub. No.: US 2022/0357430 A1
(43) Pub. Date: Nov. 10, 2022

(54) Fiber-optic Point Probe and Distance Measurement System having a Fiber-optic Point Probe

(71) Applicant: Carl Mahr Holding GmbH, Goettingen (DE)

(72) Inventor: Matthias Merschdorf, Jena (DE)

(21) Appl. No.: 17/739,597

(22) Filed: May 9, 2022

(30) Foreign Application Priority Data
May 10, 2021 (DE) 10 2021 112 120.5

(51) Int. Cl. G01S 7/481; G02B 6/26

(52) U.S. Cl. CPC G01S 7/4818; G02B 6/262

(57) ABSTRACT

A fiber-optic point probe for a distance measurement system has an optical fiber that can be connected to a light source or an evaluation device. Illumination light is transmitted via the optical fiber to a beam-forming element and is converted into beam-formed illumination light. The beam-formed illumination light is guided along a first optical axis to a planar surface of a deflection element and is reflected thereby. The beam-formed illumination light reflected on the planar surface spreads along a second optical axis, exits on a spherical end surface of the deflection element and forms a focused illumination beam having a focus area outside of the deflection element. An object surface arranged in the focus area can be probed such that a distance relative to a probe internal reference surface can be determined in a contactless manner.

### RELATED APPLICATION(S)

This application claims the benefit of German Patent Application No. 10 2021 112 120.5, filed May 10, 2021, the contents of which are incorporated herein by reference as if fully rewritten herein.

### TECHNICAL FIELD

The invention refers to a fiber-optic point probe that is configured for use in a distance measurement system. The invention also refers to the distance measurement system comprising the fiber-optic point probe. The distance measurement system is configured to evaluate an interaction between an illumination beam emitted from the fiber-optic point probe and measurement light created due to the interaction with an object surface and received by the fiber-optic point probe. The evaluation of the measurement light can be carried out interferometrically.

### BACKGROUND

Tactile probe systems with optical sensors that comprise opto-electronical converters for position determination of a probe element are known from the prior art. Such tactile probe systems are, for example, described in DE 198 16 270 A1, DE 298 23 884 U1 or DE 198 16 272 A1. However, a mechanical deflection and a contact probing of an object surface is required.

A contactless optically measuring point probe is described in Dietz et al. “An alternative to the laser. A white light measurement method enters the sub-μm-range”, Sensor Magazin 4(1997), pages 15-18 [original title: “Eine Alternative zum Laser. Ein Weiβlicht-Messverfahren dringt in den Sub-μm-Bereich ein”]. The point probe is a chromatic confocal operating point probe with beam-forming optic for distance measurement in the direction of the optical axis. Such a point probe is offered by the company Precitec Optronik GmbH (www.precitec-optronik.de). However, the dimensions of available probes are relatively large and only usable in a limited manner at locations that are difficult to reach, such as small bore holes.

Fiber-optic point probes can also comprise GRIN-lenses (Gradient Index Lenses). An optical sensor using a GRIN-lens is, for example, known from U.S. Pat. No. 4,806,016 A or DE 10 2005 023 351 A1. Moreover, Hofstetter, D. et al. describe in “Monolithically integrated optical displacement sensor in GaAs/AlGaAs”. Electr. Letters 31(1995), pages 2121-2122 the use of GRIN-lenses in a confocal measurement path of a Michelson interferometer for path measurement.

A probe for automatic testing of surfaces by using laser light is disclosed in DE 32 32 904 A1. The light reflected by an object surface is evaluated separately in a bright field and in a dark field.

The probe known from DE 197 14 202 A1 for optical testing of surfaces creates illumination light that is directed by means of beam splitting or deflection onto two distinct locations on a surface to be tested.

DE 20 2017 001 834 U1 refers to a tactile probe with integrated fiber-optic point probe, wherein it can be measured sequentially or also simultaneously in a tactile and/or optical manner.

Rao, Y.-C. et al. “Recent progress in fibre optic low-coherence interferometry”. Meas. Sci. Technol. 7(1996), pages 981-999 describes measurement systems in which short coherent light having a short coherence length less than approximately 100 μm is used and the measurement light for distance determination can be evaluated interferometrically.

An opto-electronic measurement method for absolute distance measurement is known from DE 103 17 826 A1. Measurement light that is reflected and/or scattered by an object surface is transmitted to an evaluation device that operates interferometrically according to the Michelson principle. DE 10 2005 061 464 A1 discloses an advancement by using light from multiple light sources with different medium wavelengths. In doing so, the evaluation accuracy for a distance measurement can be improved. Such a method and a device suitable for this purpose are also described in Depiereux, F. et al. “Fiber-optical sensor with miniaturized probe head and nanometer accuracy based on spatially modulated low-coherence interferogram analysis”. Appl. Opt. 46(2007), pages 3425-3431.

DE 10 2018 217 285 A1 discloses a probe system for optical and tactile measurement of at least one measurement object. A probe comprises a spherical light transparent body that is used for tactile probing of an object surface. Moreover, light can be focused from the interior on the boundary surface of the spherical body, such that a point that is probed in a tactile manner on the object surface can be detected by a microscope camera and the two-dimensional image can be analyzed in an image analysis. An optical distance measurement is not possible.

DE 100 57 539 A1 discloses an interferometric measurement device for measurement of distances and distance changes and surface parameters and shapes derived therefrom. For this purpose a probe comprises an optical fiber at the free end of which light can be emitted and reflected and/or scattered light can be received. For this purpose the free end of the optical fiber can be, for example, configured as lens or prism.

Another optical measurement probe is known from DE 10 2004 011 189 A1. The probe has an optical fiber that emits light that is deflected by means of a deflection element. In the light path between the optical fiber and the deflection element or in the light path between the deflection element and an object surface to be measured, a zone lens is arranged comprising a strong chromatic aberration. The geometrical arrangement of the elements is such that a large opening angle of the emitted light in direction toward the measurement surface is achieved in order to obtain a numerical aperture larger than 0.3.

The point probe according to DE 10 2008 050 258 A1 comprises a probe body into which illumination light is coupled in form of a beam that is deflected at the free end of the probe body by means of a deflection element and that is directed through an exit window in the probe body onto an object surface. The deflection surface of the deflection element is curved and thus configured in a beam-forming manner. Such probes are offered by the company fionec GmbH (www.fionec.de).

Fiber-optic probes for distance measurement have to be constructed for each application based on a plurality of application dependent parameters. Parameters that are of importance for the constructive characteristics of a probe comprise, for example, the length of a focus area, the minimum and/or maximum diameter of the focus area (measurement spot size on the object surface), a desired or required numerical aperture of the illumination beam emitted on the object surface, an imaging scale or a magnification in the light path of the illumination light, the desired emission angle of the illumination beam with reference to a longitudinal axis of the probe body, a desired measurement distance between the exit surface of the illumination beam and the object surface to be measured, the accessibility of the measurement site on the object surface, etc. Due to the variety of the parameters to be considered, the development and construction of a fiber-optic point probe adapted to one application is very cumbersome. The costs for development and construction of such fiber-optic point probes are therefore high.

It can be considered as one object of the present invention to provide a fiber-optic point probe that is configured for distance measurement and that comprises a constructive configuration that simplifies the adaption to different applications.

### SUMMARY

This object is solved by means of a fiber-optic point probe and a distance measurement system having the features described herein.

The fiber-optic point probe according to the invention is configured for optical distance measurement and can be used in a distance measurement system that operates optically and particularly interferometrically. It comprises an optical fiber having a preferably centrally arranged fiber core, wherein the optical fiber is configured to be connected at an entry coupling site with at least one and preferably multiple monochromatic or narrow band light sources. The optical fiber of the point probe is preferably provided with a plug-in connector for connection to the further distance measurement system, such as to one or more light sources and to the evaluation device. The entry coupling site is coupled on the inlet site with at least one monochromatic or narrow band light source, e.g. via at least one additional optical fiber. The connection with the at least one light source can be configured as pigtail in each case. The at least one light source or the preferably two light sources comprise in a preferred embodiment a narrow band spectrum having a spectral half width (full width at half maximum) of maximum 100 nm or maximum 80 nm or maximum 50 nm. The spectral half width can have an amount of minimum 4 nm or minimum 15 nm. In an embodiment with multiple, preferably two, light sources the light sources comprise different medium wavelengths or centroid wavelengths having a difference that is preferably not larger than 200 nm and can be in the range of 15 nm to 100 nm, for example. Preferably each provided light source is realized by exactly one super-luminescence diode (SLD).

The illumination light of the at least one narrow band light source coupled in at the entry coupling site is guided by means of the optical fiber from the entry coupling site to a fiber end at which the illumination light exits at least partly. The illumination light exiting at the fiber end from the fiber core is divergent. The optical fiber is preferably a single-mode optical fiber.

For interferometric evaluation or distance measurement the illumination light is reflected back partly as reference light at one single reference surface and is formed to an illumination beam that is focused on the object surface, reflected back there as measurement light and at least partly received by the fiber-optic point probe. The portion of the illumination light that is formed into the illumination beam can be larger than the portion of the illumination light that is reflected back as reference light. The measurement light and the reference light can be brought to interfere with each other and therefrom a distance measurement value between the fiber-optic point probe and the object surface can be determined therefrom by means of known methods.

The fiber-optic point probe also comprises an optical beam-forming element that receives illumination light in propagation direction of the illumination light after the fiber end of the optical fiber on a first surface and beam-forms it such that beam-formed illumination light is created having a lower divergence or being non-divergent that is emitted along a first optical axis. The beam-formed illumination light is preferably collimated or focused.

The center point of the fiber end of the optical fiber, particularly the center point of the fiber core, can be arranged on the first optical axis. The first optical axis can also be the optical axis of the divergent illumination light exiting the fiber core at the fiber end of the optical fiber.

The point probe comprises a deflection element that is configured for receiving the beam-formed light and that comprises a planar surface orientated obliquely to the first optical axis. The planar surface is configured to reflect the received beam-formed light in a direction, such that a second optical axis is created that confines a deflection angle with the first optical axis unequal to 180°. The two optical axes intersect each other and form a point of intersection. The deflection element further comprises a spherical end surface. The center of curvature of the spherical end surface is located on the point of intersection of the first optical axis with the second optical axis. Due to this arrangement, an illumination beam is created that is emitted outwardly from the fiber-optic point probe in a manner focused by means of the spherical end surface and directed on the object surface. A focus area of the focused illumination beam is arranged in direction of the second optical axis with distance to the spherical end surface.

The focused illumination beam is scattered and/or reflected at a measurement site on the object surface. Due to the interaction with the object surface measurement light is formed that enters at least partly through the spherical end surface into the fiber-optic point probe and is transmitted to an evaluation device. The light path of the measurement light—at least up to the fiber end of the optical fiber—is substantially opposite to the light path of the illumination light. The measurement light is received and collimated by means of the spherical end surface, is reflected on the planar surface of the deflection element, travels through the beam-form element, is focused thereby and at least partly received by the optical fiber at the fiber end. Together with the reference light the measurement light is then guided to an exit coupling location by means of the optical fiber, wherein the optical fiber guiding the reference light as well as the measurement light is configured to be connected with an evaluation device adjacent to the exit coupling site.

The evaluation device can use the reference light and the measurement light received at the exit coupling location in order to determine a distance to the measurement site on the object surface therefrom. The exactly one reference surface on which the illumination light is partly reflected back into itself serves as reference point for quantitative determination of the distance measurement value. This exactly one reference surface is located in the light path of the illumination light of the fiber-optic point probe and preferably comprises a shape that is substantially congruent to the wave front of the incident—optionally beam-formed—illumination light. The reference surface is particularly configured to allow a partial reflection. In a preferred embodiment the reference surface is the light exit surface at the fiber end of the optical fiber.

The distance measurement value describes the distance between the spherical end surface of the fiber-optic point probe and the measurement site on the object surface.

The evaluation device operates particularly interferometrically based on a method, as described in DE 10 2005 061 464 A1. Also, other methods and particularly interferometric methods can be used for determination of the distance.

The deflection element can be, for example, a hemisphere. The spherical end surface then forms a surface section of the hemisphere.

The arrangement of the deflection element such that the center of curvature of the spherical end surface is the point of intersection of the two optical axes allows simple variation of the deflection angle under which the two optical axes intersect. The illumination beam can thus be emitted from the fiber-optic point probe in different directions by means of a simple change of the orientation of the planar surface. Thereby all other optical characteristics remain preferably unchanged, apart from the deflection angle. Moreover, depending on at least one application dependent parameter the same constructive configuration can be used without substantial changes. For example, the at least one application dependent parameter can be the length of a focus area, the minimum and/or maximum diameter of the focus area (measurement spot on the object surface), a desired or required numerical aperture of the illumination beam emitted on the object surface, an image scale or magnification in the light path of the illumination light, the desired emission angle of the illumination beam with reference to a longitudinal axis of the probe body, a desired measurement distance between the exit surface of the illumination beam and the object surface to be measured, the accessibility of the measurement site on the measurement surface or an arbitrary combination thereof. The characteristic of the fiber-optic point probe can be easily influenced, e.g. by varying the curvature of the spherical end surface and/or the distance between the planar surface of the deflection element from the first surface of the beam-forming element in direction of the first optical axis. Thus, an adaption to different applications is possible without cumbersome new development. A modular construction system is provided in which different fiber-optic point probes can be configured by dimensioning and/or selection of standard elements of the modular construction system for adaption to the application.

It is advantageous, if the fiber-optic point probe comprises a probe body. An end section of the optical fiber comprising the fiber end and optionally additionally the beam-forming element is or are arranged on or in the probe body. The probe body can connect the end section of the optical fiber comprising the fiber end with the beam-forming element mechanically and/or optically. The probe body can be a one-part or multiple-part body and can have, for example, at least in sections a hollow cylindrical form or sleeve form. In a preferred embodiment the probe body is surrounded by one or multiple probe sleeves. One single probe sleeve is sufficient. A deflection element can be arranged in or at the probe body and/or the probe sleeve and can be mechanically connected with the probe body and/or the probe sleeve, preferably outside of the light path of the illumination light. For example, the mechanical connection can be a substance bond and/or can be established by means of an adhesive layer. Thereby the spherical end surface of the deflection element can be completely or at least partly arranged inside the probe sleeve and/or inside the probe body. If the spherical end surface is at least partly arranged inside the probe sleeve, the probe sleeve can comprise a window adjacent to the spherical end surface such that the light emission out of the spherical end surface is completely allowed and the light incidence into the spherical end surface is at least predominantly allowed. The window can be a through-hole or can be realized by a cover that is transparent for the used light wavelength.

In an embodiment the beam-forming element is completely located inside the probe body or inside a probe sleeve.

The beam-forming element and the deflection element can be separate optical elements or can form a common monolithic body. In the latter case the beam-forming element and deflection element are configured integrally without interior beam-forming boundary surface and/or joint surface. In a monolithic or integral configuration the beam-forming element can be formed by a spherical surface or a spherical surface section of the deflection element, as an example. In this embodiment a very compact configuration of the fiber-optic point probe is achieved.

If the beam-forming element and the deflection element are separate bodies and thus also separate optical elements, the respective optical characteristics can be achieved independent from each other in a simple manner. For example, the beam-forming element can be a spherical element (e.g. a ball), a lens and particularly a GRIN-lens (Gradient Index Lens). It is also possible to arrange multiple beam-forming elements in the light path of the illumination light that have different geometrical shapes and/or different optical characteristics.

In an embodiment the deflection element that is separate from the beam-forming element can comprise a second surface facing the beam-forming element that is configured for receiving the beam-formed light. The second surface can be a planar surface or a spherical surface. The second surface can have the same radius of curvature as the spherical end surface of the deflection element. The second surface and the spherical end surface can be formed by a surface section of a common spherical surface of the deflection element respectively, e.g. if the deflection element is realized as hemisphere. A third surface of a directly adjacent optical element is facing the second surface of the deflection element, wherein the third surface can be formed on the beam-forming element, for example. The third surface can abut entirely in a two-dimensional manner against the second surface or can be arranged with distance to the second surface. Preferably the curvature of the third surface is equal to the curvature of the second surface of the deflection element, wherein the curvature can also be equal to zero. Particularly, the second surface is a planar surface or a convexly curved surface and the third surface can be a planar surface or a concavely curved surface. The center of all of the surface curvatures in the light path of the illumination light up to the planar surface of the deflection element is located on the first optical axis.

It is further advantageous, if the numerical aperture of the illumination beam after focusing by means of the spherical end surface of the deflection element is less than 0.3. The numerical aperture of the illumination beam can be in a range from 0.05 to 0.12 and can amount to approximately 0.1 in an embodiment.

The dimension of the focus area of the illumination beam along the second optical axis that can be evaluated by means of the evaluation device has a length of maximum 200 μm or maximum 150 μm. In an embodiment the length is approximately 80 μm.

It is advantageous, if the difference in the refractive index of the materials at each boundary surface of two optical materials in the light path of the illumination light between the fiber end of the optical fiber and the planar surface of the deflection element, that are not used as reference surface, is at most 0.3. At each of these boundary surfaces the material transition is configured such that the refraction indices of the materials—including potentially provided adhesive layers—differ from each other by maximum 0.3. This applies particularly for a transition between the fiber end of the optical fiber and the beam-forming element and/or between the beam-forming element and the deflection element or non-beam-forming spacer elements that can be arranged in the light path of the illumination light between the light exit surface of the fiber core and the deflection element as an option, wherein the transition is free of air gaps and preferably comprises an adhesive layer. Due to this measure, reflections of the illumination light prior to the exit from the spherical end surface can be reduced. Such reflections are undesired, because they disturb the evaluation of the measurement signal and affect the measurement accuracy.

In an embodiment at least one air gap can be present in the light path of the illumination light between the fiber end of the optical fiber and the deflection element. Optical surfaces that adjoin the air gap and are not configured as reference surface, but serve to emit or receive illumination light, are preferably provided with an anti-reflection coating (AR-coating). Due to this anti-reflection coating, also reflections can be reduced or avoided in the light path of the illumination light that could disturb the evaluation of the measurement signal and could affect measurement accuracy.

Apart from a boundary surface that is used as reference surface and apart from cemented boundary surfaces of elements having identical refractive indices, all other optical surfaces in the light path of the illumination light, particularly from the fiber end of the optical fiber up to the end surface of the deflection element, where the difference in the refractive index is higher than 1.0 can have a shape that is not congruent to the wave front of illumination light that is incident on or that is emitted from the boundary layer. Due to this measure, it is avoided that illumination light is reflected back. Thereby reflections in the light path of the illumination light can be reduced or avoided also that disturb the evaluation of the measurement signal and affect the measurement accuracy.

In an embodiment or in multiple embodiments at least one spacer element that is not configured for beam-forming can be arranged in the light path of the illumination light between the fiber end of the optical fiber and the deflection element, i.e. for example between the fiber end of the optical fiber and the beam-forming element and/or between the beam-forming element and the deflection element. The at least one spacer element is transparent for the illumination light and can consist of the same material as the beam-forming element and/or the deflection element, for example. Such a spacer element can be arranged in the light path of the illumination light instead of providing an air gap, e.g. in order to adjust the difference in the refractive indices at optical boundary surfaces and particularly to keep such a difference as low as possible and/or in order to specifically influence the dispersion, particularly the group velocity dispersion, in the fiber-optic point probe by means of the light path of the illumination light inside the spacer element.

In an embodiment in which a spacer element is arranged between the beam-forming element and the deflection element, the spacer element can have the third surface on its side facing the deflection element, as it has already been explained above. In this case, the processing of the third surface can be carried out advantageously independent from any beam-forming element in the upstream light path, particularly in case of the use of GRIN-lenses as component of the beam-forming element.

Particularly advantageous is the arrangement of the spacer element between the beam-forming element and the deflection element for fixation of the deflection element such that the deflection element is adhesively bonded with the spacer element by means of an adhesive layer arranged in the light path of the illumination light. In doing so, the attachment of the deflection element at the probe body and/or the probe sleeve can be avoided.

The reflection on the planar surface of the deflection element can be achieved by Total Internal Reflection (TIR) in that a sufficiently high amount of the difference between a first refractive index n1 of the deflection elements and a second refractive index n2 of the optically thinner medium or optically thinner material (n2<n1) adjoining the planar surface of the deflection element is realized, particularly by means of an optionally present additional element. For the illumination light incident on the planar surface of the deflection element under an angle of incidence α in the optical thicker material of the deflection element, total reflection occurs if the angle of incidence α is greater than the critical angle of the total reflection θ:

α>θ (1)

θ=arcsin (n2/n1) (2)

Alternatively to the Total Internal Reflection, the planar surface can also be provided with a reflective layer. The reflective layer can cause a reflection of the illumination light (totally reflective layer). Alternatively, the reflective layer can be partially reflecting such that the illumination light is split in two parts. Particularly in case of the beam splitting, the optionally provided additional element can be transparent for the light wavelengths of the illumination light.

Particularly in case of hemispherical deflection elements and with a large angle of incidence α, the additional element can simplify the attachment of the deflection element and the stability of the attachment. In addition, the additional element can protect the planar surface of the deflection element from mechanical damage.

In a preferred embodiment the additional element is formed by a hemisphere, such that it is possible to form a ball from the deflection element and the additional element. As an option, the additional element can be configured to be used as tactile probing element. The additional element has no optical functional surface on its side facing away from the deflection element and can thus be used for tactile probing without putting the optical functional surfaces of the fiber-optic point probe at risk of damages (e.g. scratches) and/or deformations due to wear. In this option the planar surface of the deflection element is preferably mirroring.

The material of the deflection element can have a first refractive index n1 of higher than 1.6, for example. In an embodiment the deflection element and/or the beam-forming element consist of high refractive glass or sapphire. However, also fused silica having a first refractive index n1 of approximately 1.46 can be used.

It is in addition advantageous, if a coating is provided on the spherical end surface of the deflection element. The coating can have a higher hardness than the hardness of the material of the deflection element. It can serve as protection layer so-to-speak in order to protect the spherical end surface of the deflection element from damages. In addition or as an alternative, the coating can also be an anti-reflection coating in order to reduce the reflectivity.

A distance measurement system can comprise one or more embodiments of the fiber-optic point probe, as it has been described above. Also the at least one monochromatic or narrow band light source as well as the evaluation device that are coupled with the optical fiber of the fiber-optic point probe are part of the distance measurement system. The evaluation device of the distance measurement system is configured to determine a distance measurement value based on the received reference light and the received measurement light, wherein the distance measurement value comprises or describes the distance between the spherical end surface of the deflection element and the measurement site on the object surface. The evaluation of the measurement light is preferably carried out interferometrically.

Advantageous embodiments of the invention are derived from the dependent claims, the description and the drawings. In the following, preferred embodiments of the invention are explained in detail with reference to the attached drawings. The drawings show:

### BRIEF DESCRIPTION OF THE DRAWINGS

FIG. 1 a schematic basic illustration of the distance measurement system comprising a fiber-optic point probe,

FIGS. 2 to 8 a schematic basic illustration of an embodiment of a fiber-optic point probe respectively comprising a beam-forming element and a deflection element that are arranged in and/or on a probe body,

FIGS. 9 to 20 a schematic basic illustration of an embodiment of the beam-forming element and/or the deflection element for a fiber-optic point probe respectively,

FIGS. 21 to 24 further embodiments of a beam-forming element and/or deflection element respectively provided with beam splitting for a fiber-optic point probe in a schematic basic illustration respectively and

FIGS. 25 and 26 a schematic basic illustration of an end section of an optical fiber for a fiber-optic point probe respectively.

### DETAILED DESCRIPTION

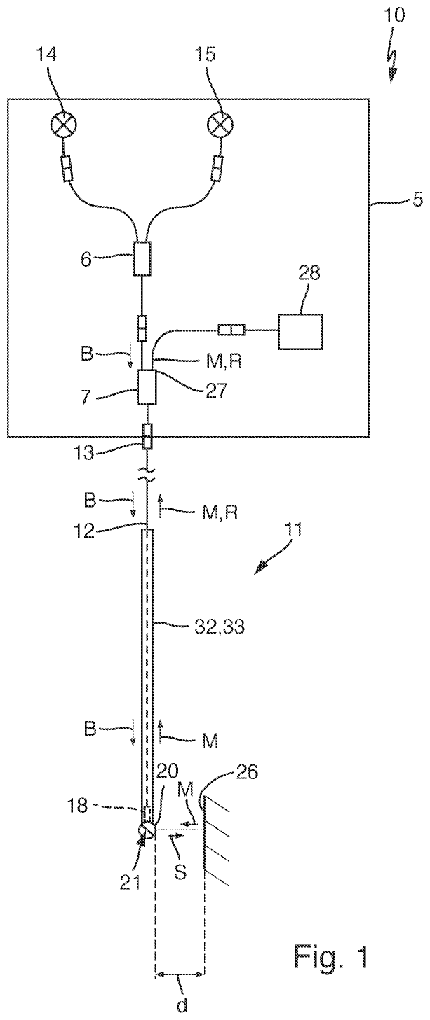

FIG. 1 schematically illustrates a distance measurement system 10 comprising a fiber-optic point probe 11. The fiber-optic point probe 11 has an optical fiber 12. At an entry coupling site 13 an illumination and evaluation device 5 is connected to the optical fiber 12, wherein the illumination and evaluation device 5 comprises a monochromatic or narrow band light source 14, 15, according to the example a first light source 14 and a second light source 15. The light sources 14, 15 are preferably provided with a pigtail (connection optical fiber) in each case that provide illumination light B in a fiber-optic manner for the one or more optical fibers 12 arranged one after another. In the embodiment illustrated here the first light source 14 and the second light source 15 are coupled with the fiber-optic inlets of a first Y-fiber coupler 6 (2:1 fiber coupler)—preferably via the respective pigtail—wherein the fiber-optic outlet of the Y-fiber coupler 6 is directly or indirectly connected with the entry coupling site 13 of the optical fiber 12. Instead of the first Y-fiber coupler 6, also an X-fiber coupler (2:2 fiber coupler) can be used, for example, wherein its second fiber-optic outlet can remain unconnected or can be advantageously used for monitoring the light sources 14, 15.

The two light sources 14, 15 emit monochromatic or narrow band light respectively that has a spectral half width of less than 100 nm respectively in the embodiment. The medium light wavelength or centroid wavelength of the light of the first light source 14 and the light of the second light source 15 are different from each other, e.g. about at least 15 nm or at least 40 nm. Each of the light sources 14, 15 can be configured as one super luminescence diode (SLD). The first light source 14 can have a centroid wavelength of approximately 770 nm and the second light source 15 can have a centroid wavelength of approximately 820 nm. The spectral half width of the light of each narrow band light source 14, 15 can be preferably 4 nm to 80 nm.

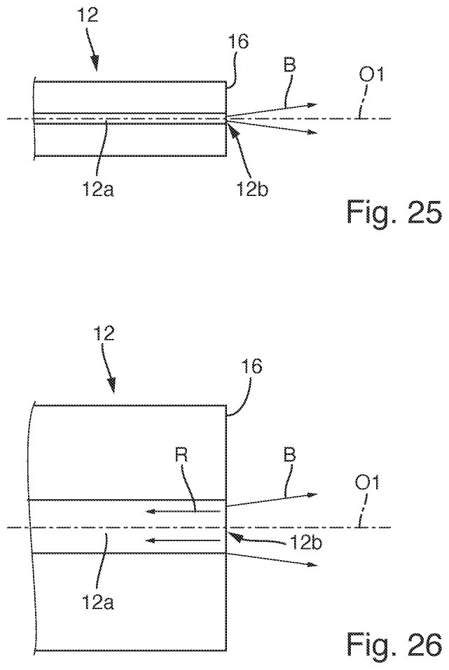

The light of the first light source 14 as well as the light of the second light source 15 is coupled into the first optical fiber 12—and particularly into a fiber core 12a arranged preferably centrally in the optical fiber 12—as illumination light B. The illumination light B is guided up to the fiber end 16 of the optical fiber 12. As it is particularly illustrated in FIGS. 25 and 26 by way of the example, at least a portion of the illumination light B exits along a first optical axis O1 at the fiber end 16 from the fiber core 12a and diverges after the fiber end 16. A portion, frequently a minor portion, of the illumination light B can be reflected on the fiber end 16 forming reference light R for interferometric evaluation. In the embodiment the face of the optical fiber 12 forms a reference surface 12b on which reference light R is formed, e.g. by means of partial reflection (FIGS. 25, 26). The reference surface 12b could also be arranged at another location in the light path of the illumination light B.

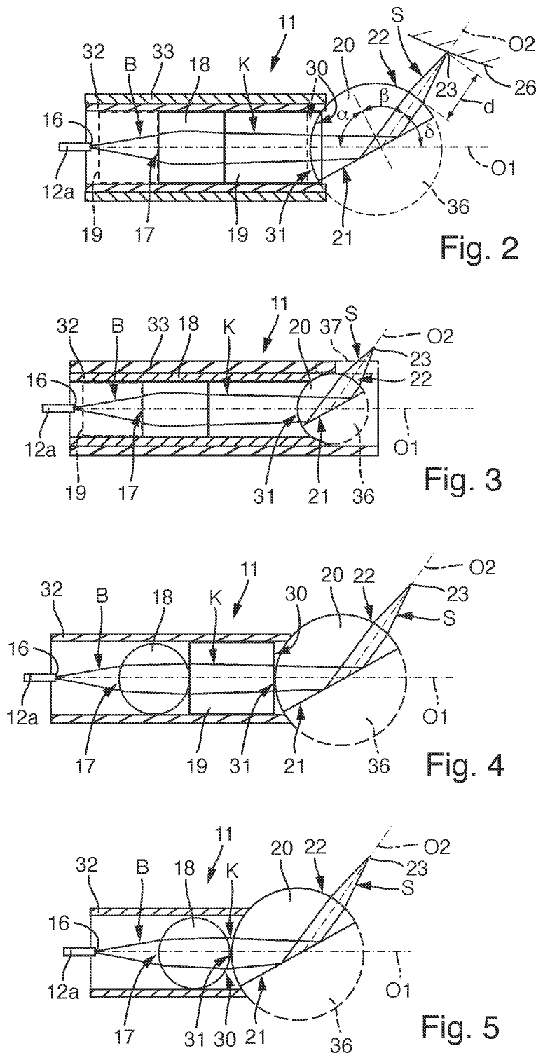

The divergent illumination light B is received on a first surface 17 of an optical beam-forming element 18. The first surface 17 is orientated orthogonal to the first optical axis O1 according to the example. The first surface 17 is facing the fiber end 16 of the optical fiber 12, wherein a distance is present between the fiber end 16 and the first surface 17. This distance can be realized by means of an air gap and/or a spacer element 19. The spacer element 19 is transparent for the light wavelengths of the illumination light B. The spacer element 19 is not beam-forming. An optionally provided spacer element 19 is illustrated by way of example in FIGS. 2 and 3. The spacer element 19 can abut against the first surface 17 and/or against the fiber end 16 of the optical fiber 12 in a two-dimensional manner.

As for example illustrated in FIGS. 2-6, the beam-forming element 18 is configured to beam-form the divergent illumination light B, such that a beam-formed illumination light K is created having a reduced divergence or being collimated or focused. Preferably the beam-formed illumination light K is collimated or focused. It is coupled into deflection element 20. The deflection element 20 has a planar surface 21. The beam-formed illumination light K is directed along a first optical axis O1 from the beam-forming element 18 onto the planar surface 21 of the deflection element 20 and is reflected there. The planar surface 21 is arranged obliquely under an angle of less than 90° relative to the first optical axis O1 such that the beam-formed illumination light K incident along the first optical axis O1 on the planar surface 21 under the angle of incidence α is reflected along a second optical axis O2 under an angle of reflection β (here: α=β) and exits the deflection element 20 through a spherical end surface 22. In doing so, a deflection angle δ is obtained between the first optical axis O1 and the second optical axis O2 (FIG. 2). By means of the spherical end surface 22, the beam-formed illumination light K is focused and forms a focused illumination beam S.

A focus area 23 of the focused illumination beam S that is only schematically illustrated as point, is arranged with distance to the spherical end surface 22. In the direction of the second optical axis O2 the focus area 23 has a length of maximum 200 μm and can be approximately 80 μm in the embodiment.

The curvature of the spherical end surface 22 has a center of curvature that corresponds with the point of intersection between the first optical axis O1 and the second optical axis O2.

The fiber-optic point probe 11 is orientated such that an object surface 26 (FIGS. 1 and 2) of an object is arranged within the focus area of the illumination beam S at a measurement site where/to which a distance d shall be determined. On the object surface 26 the illumination beam S is reflected and/or scattered. The reflected and/or scattered light is at least partly received by means of the spherical end surface 22 of the deflection element 20 and forms measurement light M that is then guided opposite to the illumination light B in the fiber-optic point probe 11. After entering into the spherical end surface 22 the measurement light M is reflected on the planar surface 21, passes through the beam-forming element 18 and is then at least partly coupled into the fiber core 12a of the optical fiber 12 at its fiber end 16.

The measurement light M and the reference light R are guided through the optical fiber 12 up to an exit coupling site 27 that connects an evaluation device 28 with the optical fiber 12 in a fiber-optic manner, such that the measurement light M and the reference light R are received in the evaluation device 28. The exit coupling site 27 can be arranged on a second Y-fiber coupler 7 (2:1 fiber coupler) between the entry coupling site 13 and the first Y-fiber coupler 6. FIG. 1 is a preferred configuration in which the exit coupling site 27 is arranged with distance to the entry coupling site 13 on the optical fiber 12. For example, an end of the optical fiber 12 opposite to the fiber end 16 can be the entry coupling site 13.

In the evaluation unit 28 a distance measurement value is determined based on the received measurement light M in relation to the also received reference light R, wherein the distance measurement value contains or describes the distance d (FIGS. 1 and 2) between the spherical end surface 22 of the fiber-optic point probe 11 and the measurement site on the object surface 26 on the second optical axis O2. The geometric reference site of the distance measurement value in the fiber-optic point probe 11 is the reference surface 12b that generates the reference light R, preferably the face on the fiber end 16 of the optical fiber 12 and particularly the planar face of the fiber core 12a (FIG. 26).

The deflection element 20 and the beam-forming element 18 can be configured as separate bodies or separate optical elements, as for example illustrated in FIGS. 2-5. The beam-forming element 18 can be a GRIN-lens (FIGS. 2 and 3) or can be realized as another collimating and/or focusing optical element, e.g. one or more lenses and/or one or more spherical elements, as shown in FIGS. 4 and 5 by way of example. Here the beam-forming element 18 is configured as ball lens.

The beam-forming element 18 can be arranged with distance to a second surface 31 of the deflection element 20. The second surface 31 is facing the beam-forming element 18 and is configured to receive the beam-formed, preferably collimated or focused illumination light K. In the embodiment illustrated in FIG. 2 the distance between the beam-forming element 18 and the second surface 31 is bridged by a non-beam-forming spacer element 19.

The optical element 18, 19, that is arranged directly adjacent to the second surface 31, has a third surface 30 facing the second surface 31, wherein the third surface 30 is provided on the spacer element 19 (e.g. FIG. 2) or on the beam-forming element 18 (e.g. FIG. 4) in the illustrated embodiments. The third surface 30 can have a curvature that is equal to the curvature of the second surface 31, including a curvature that is equal to zero. In all embodiments the second surface 31 is planar or convexly curved. The third surface 30 can be planar or concavely curved or convexly curved. In some embodiments a two-dimensional contact between the second surface 31 and the third surface 30 is realized that is at least arranged in the light path of the beam-formed illumination light K.

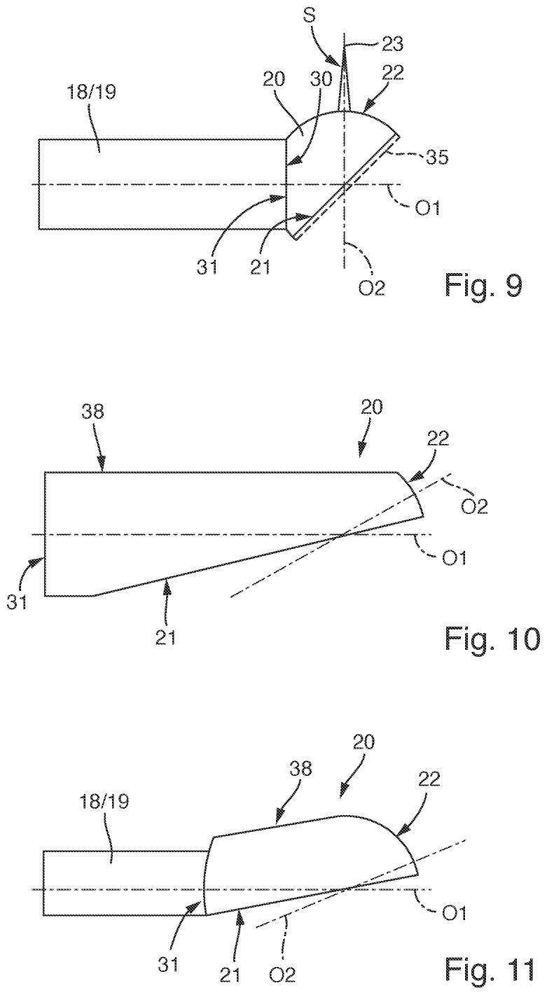

In the embodiment illustrated in FIGS. 2-8 the spherical end surface 22 and the second surface 31 are formed by surface sections of a hemispherical deflection element 20. The third surface 30 facing the second surface 31 can thus be concavely curved having a radius equal to the radius of the hemispherical deflection element 20. As also shown in FIGS. 2, 4, 5, 7 and 8, the curvatures of the facing surfaces 30, 31 can also differ from each other and the third surface 30 can be, for example, a planar surface or a convex curved surface, while the second surface 30 is convexly curved. FIG. 9 shows an embodiment in which the second surface 31 and the third surface 30 are planar surfaces that extend parallel to each other.

A spacer element 19 that is arranged between the beam-forming element 18 and the deflection element 20 is illustrated in FIGS. 2 and 4, for example. In modification thereto the gap between the beam-forming element 18 and the second surface 31 of the deflection element 20 can also be filled by a not glass-like medium, e.g. a transparent adhesive layer or air.

The fiber-optic point probe 11 comprises a probe body 32 for support of an end section of the optical fiber 12 and the optical components, wherein the probe body 32 can be sleeve-shaped in the embodiment. The probe body 32 can be surrounded by a probe sleeve 33 as an option. The probe body 32 and the probe sleeve 33 extend coaxially to the first optical axis O1. The fiber end 16 is arranged in the probe body 32, preferably such that a center axis of the fiber core 12a centrally arranged in the optical fiber 12 corresponds to the first optical axis O1.

In the embodiment illustrated here the beam-forming element 18 is arranged in the probe body 32 and is preferably entirely located inside the space surrounded by the probe body 32. The deflection element 20 is arranged on a free end of the probe body 32 and can be connected with the probe body 32 and/or the probe sleeve 33 by means of an adhesive bond. In addition or as an alternative, the deflection element 20 can be connected with an adjacent optical element, preferably by means of an adhesive bond, e.g. with the beam-forming element 18 or a spacer element 19. By way of example, an adhesive bond realized by an adhesive layer 34 between the deflection element 20 and an optical element 18 or 19 as well as the probe body 32 and/or the probe sleeve 33 is illustrated in FIG. 7.

In order to create reflections on the planar surface 21, it can be coated optionally with a partly reflecting or totally reflective layer 35 (FIG. 9). Such a reflective layer 35 is advantageous, if the angle of incidence a of the beam-formed illumination light K is less than the critical angle θ of the Total Internal Reflection:

α<θ (3)

The critical angle θ of the Total Internal Reflection is derived according to equation (2) from the first refractive index n1 of the deflection element 20 and the second refractive index n2 of the material or medium adjoining the planar surface 21 on the back side. Dependent on the desired or required deflection angle δ of the beam-formed illumination light K and the inclination angle of the planar surface 21 relative to the first optical axis O1 required therefore, the amount of the difference between the refractive indices n1, n2 at the planar surface 21 has to be sufficiently high in order to be able to omit the reflective layer 35. A surrounding atmosphere, particularly air, can adjoin the planar surface 21, as it is by way of example illustrated in the embodiments of the deflection element 20 according to FIGS. 2-6, (without additional element 36) and FIGS. 9-13.

As an alternative to the atmosphere or air, also an additional element 36 connected to the deflection element 20 can be arranged on the planar surface 21. In the embodiments illustrated in FIGS. 2-7 the material of the additional element 36, in case it is provided optionally, has preferably a lower refractive index than the deflection element 20. Particularly in case of larger angles of incidence α, the additional element 36 in combination with the adhesive layer 34 (FIGS. 7 and 8) can be realized as connected, common unit. The additional element 36 can stabilize the attachment of the deflection element 20, particularly on the beam-forming element 18 or on the spacer element 19 and can concurrently provide a mechanical protection of the planar surface 21 of the deflection element 20.

If the deflection element 20 is configured as hemisphere, the additional element 36 can be preferably also configured as hemisphere having the same radius, such that a deflection element 20 together with the additional element 36 form a ball (compare e.g. FIG. 1-7, 14, 15, 18-20 or 22). For fulfilling the condition of equations (1) to (3), regularly the planar surface 21 is provided with a reflective layer 35 in this case.

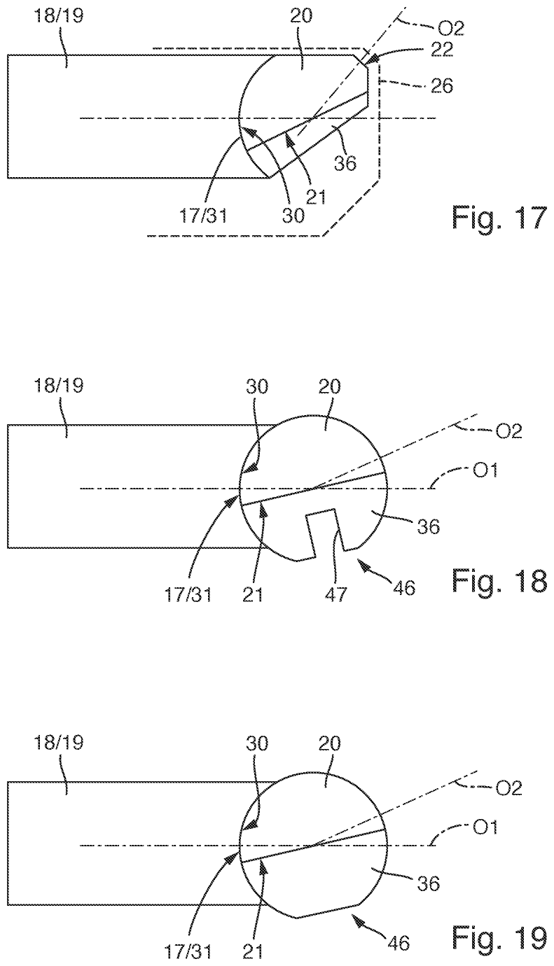

The additional element 36 can also have an arbitrary other shape that differs from the hemisphere in other embodiments (compare particularly FIGS. 8 and 17).

The deflection element 20 and the additional element 36 are two-dimensionally connected with each other at the planar surface 21, preferably by means of an adhesive bond.

On the additional element 36 no optical functional surface is provided in some embodiments. A beam-formed illumination light K or the measurement light M does not pass through the additional element 36 such that its outer surface facing away from the deflection element 20 can be used for tactile probing. The additional element 36 can thus form a tactile probing element. In this case the fiber-optic point probe 11 can be additionally configured to probe an object surface 26 with contact, whereby preferably the additional element 36 is used as probing element in order to avoid damages on the light emitting or light receiving surfaces, particularly on the spherical end surface 22 of the deflection element 20.

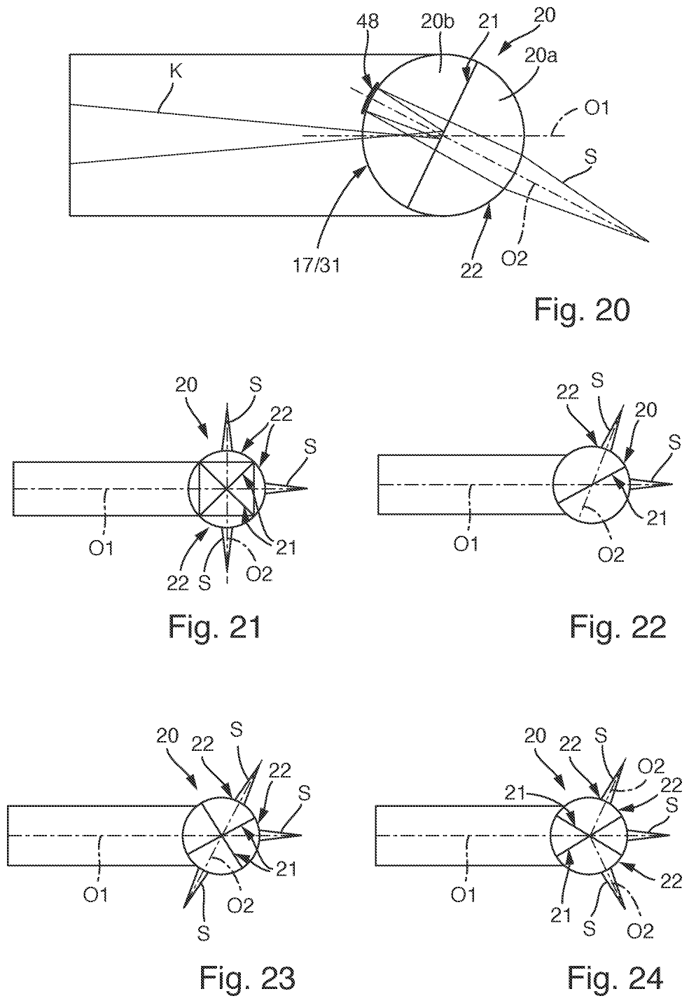

As an alternative to this, the additional element 36 can comprise an optical functional surface in other embodiments, particularly, if a splitting of the (beam-formed) illumination light is caused, e.g. in order to obtain more than one illumination beam S (FIGS. 20-24).

In order to be able to also use the fiber-optic point probe 11 for tactile probing, it is advantageous, if the diameter of the ball consisting of the deflection element 20 and the additional element 36 is larger than the outer diameter of the probe body 32 or as an option of the probe sleeve 33 (e.g. FIGS. 2 and 4-6). In other embodiments the diameter of the ball of deflection element 20 and additional element 36 is smaller than the outer diameter of probe sleeve 33, as illustrated in FIG. 3 by way of example. In this embodiment the deflection element 20 can be partly—at least up to the intersection point of the optical axis O1, O2—or entirely located in the interior of a sleeve formed by the probe body 32 or the probe sleeve 33. In doing so, the outer surfaces of the deflection element 20 are protected from damages in case of mechanical contact with an object. Then it is advantageous or required to provide the surrounding sleeve of the probe body 32 or the probe sleeve 33 with an area that is transparent for the used light or preferably with a window 37, as only highly schematically shown in FIG. 3. The window 37 is arranged such that the illumination beam S can be emitted in an unimpeded manner through the spherical end surface 22 and reaches the object surface 26 and that measurement light M reflected or scattered from there can at least partly be received unimpeded by the spherical end surface 22.

It is to be noted here that the light path in the emission direction and the light path of the received measurement light M do not have to be entirely identical. This is usually only the case, if the second optical axis O2 intersects the object surface 26 orthogonally. If, however, the second optical axis O2 intersects the object surface 26 obliquely, the measurement light received by the spherical end surface 22 is not received at the same location at which the illumination beam S exits. The spherical end surface 22 is thus preferably not limited to an area that is required for emitting the illumination beam S, but is preferably larger in all directions radial to the second optical axis O2 than the area required for the emission of the illumination beam S. If the probe sleeve 33 and/or the probe body 32 surrounds the deflection element 20 at least partly, it can be advantageous to provide a largely dimensioned window 37 in the surrounding part of the sleeve adjoining the spherical end surface 22, as described above and as schematically shown in FIG. 3. The numerical aperture of the optical fiber 12, particularly its fiber core 12a, at the fiber end 16, which is identical for the exiting illumination light B and for the measurement light M to be coupled into the optical fiber 12, is finally limiting for the measurement light M guided into the evaluation device 28 via the optical fiber 12. Light from the object surface 26 that is incident outside of the acceptance angle onto the fiber end 16, which is defined by the numerical aperture of the optical fiber 12, gets lost and the measurement light M that can be evaluated is weakened.

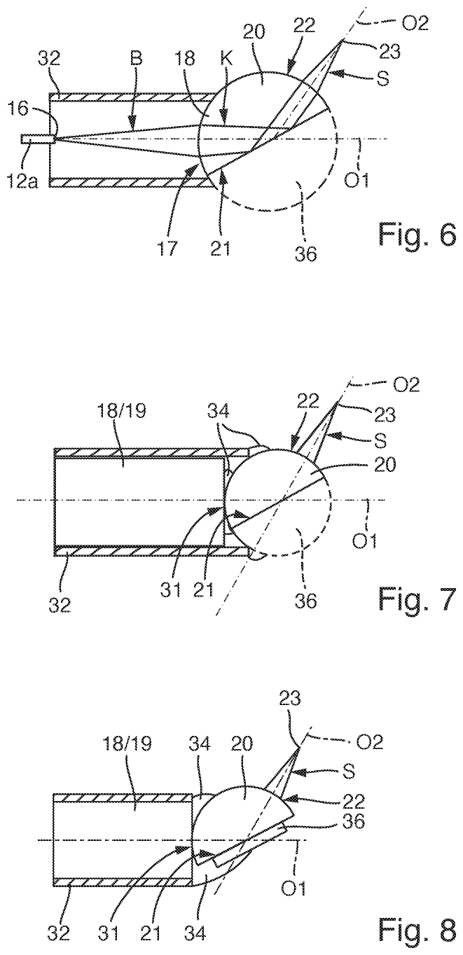

In the embodiment shown in FIG. 6 the beam-forming element 18 and the deflection element 20 form a monolithic body, e.g. a hemisphere. The first surface 17 is realized by a surface section of this hemisphere while another surface section is the spherical end surface 22. The beam-forming of the divergent illumination light B is thereby carried out by means of the surface section of the hemisphere that forms the first surface 17. In this embodiment a very simple configuration and a compact arrangement can be achieved. The second surface 31 and the third surface 30 are omitted in case of the integral configuration of the beam-forming element 18 and the deflection element 20.

The deflection element 20 can be configured integrally as non-hemispheric monolithic body. Different embodiments are by way of example illustrated in FIGS. 10 and 11.

FIG. 10 shows an embodiment of the deflection element 20 in a rod-like longitudinal configuration along the first optical axis O1. Compared with a hemisphere the spherical end surface 22 is smaller and corresponds approximately to the surface of one-eighth of a ball. On one side it adjoins the planar surface 21 and on another side it adjoins an outer surface 38 of deflection element 20 that can extend coaxially around the first optical axis O1, for example. The second surface 31 for receiving the beam-formed illumination light K is orientated orthogonal to the first optical axis O1 in this embodiment. Alternatively to this, the second surface 31 can also be configured as spherical surface having a center of curvature on the first optical axis O1, as illustrated in FIG. 11. The center of curvature of the second surface 31 is preferably located on the planar surface 21. Different to FIG. 10, the outer surface 38 is orientated coaxially to a cylinder axis that extends approximately parallel to the planar surface 21 or is inclined under another angle relative to the first optical axis O1. While the size of the spherical end surface 22 is equal to one-eighth of a ball in FIG. 10, the deflection element 20 of FIG. 11 comprises a spherical end surface 22, the size of which is approximately equal to one-fourth of a ball. Features of these two embodiments can also be combined with each other.

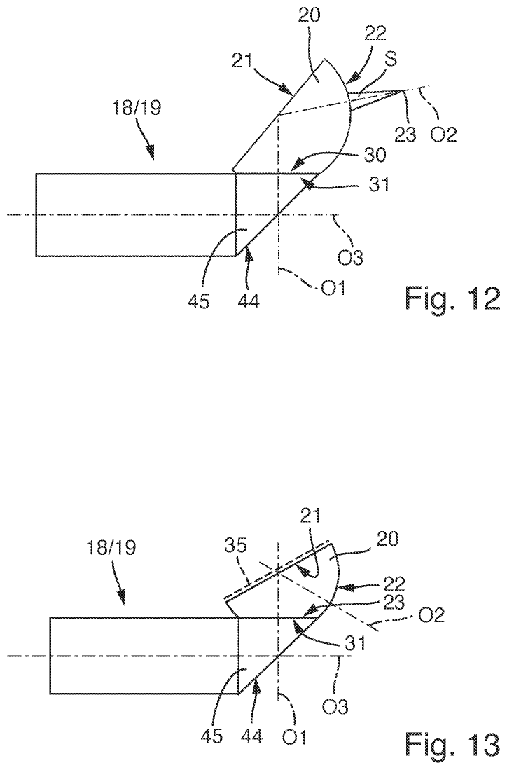

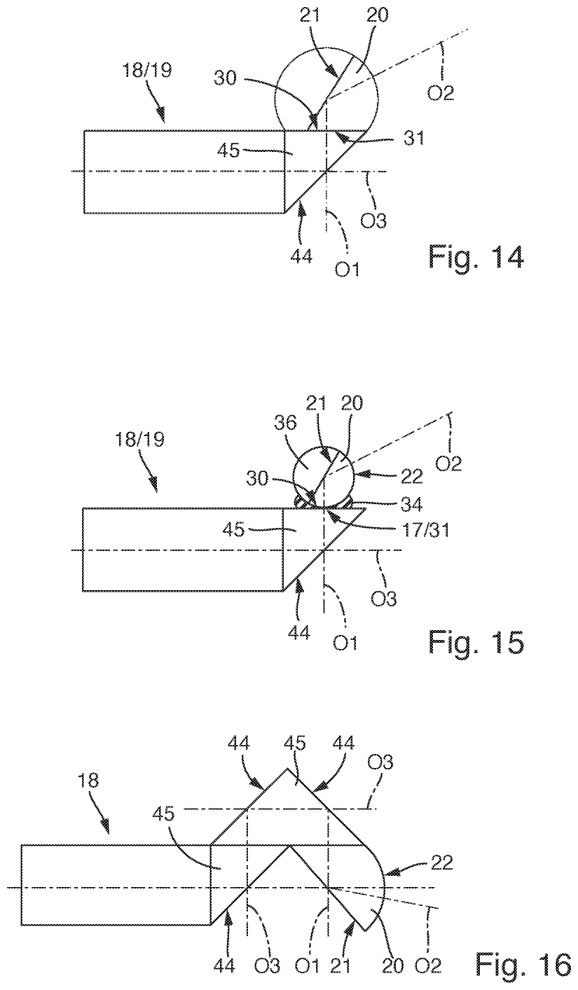

In the embodiments illustrated in FIGS. 12-15 the deflection element 20 is realized by an entire or cut hemisphere and comprises the spherical end surface 22 as well as the planar surface 21. The arrangement of adjacent optical elements including the beam-forming element 18 and/or an optional spacer element 19 comprises at least one reflection surface 44 in these embodiments on which the illumination light B or the beam-formed illumination light K is deflected from a direction along the third optical axis O3 in a direction along the first optical axis O1. In doing so, the emission direction of the illumination light B out of the fiber end 16 can be different from the first optical axis O1 and can, for example, extend along the third optical axis O3. The third optical axis O3 can be identical with the center axis of the probe body 32 and/or the probe sleeve 33 and/or can extend through the center point of the fiber core 12a at the fiber end 16 of the optical fiber 12, for example. Therefore, in addition to the reflection on the planar surface 21, a further deflection can be present in the light path.

In modification to these embodiments according to FIGS. 12-15, the beam-forming element 18 can comprise multiple reflection surfaces 44 arranged obliquely relative to one another in order to deflect the light multiple times. Only by way of example an embodiment having three reflection surfaces 44 and having multiple third optical axes O3 is illustrated in FIG. 16.

The reflection on the reflection surfaces 44 can be achieved by means of Total Internal Reflection (TIR) or by means of a reflective layer 35, preferably configured as mirroring layer. One or more of the present reflection surfaces 44 can be arranged on a prismatic part 45, for example, whereby each prismatic part 45 can be a separate body or can be an integral part of another optical element, particularly the beam-forming element 18 or an optionally provided spacer element 19.

FIG. 17 illustrates an embodiment of the deflection element 20 that reduces by way of example the deflection element 20 according to FIG. 2 down to the optically and/or the sections used optically and/or for adhesive bond purposes. It is configured similarly to the deflection element 20 of FIG. 10. Different to FIG. 10, the second surface 31, that is configured for receiving the beam-formed illumination light K, is configured spherically. On the planar surface 21 an additional element 36 is arranged. This embodiment is particularly configured for measurement in very narrow cavities or bores that form the object surface 26.

For adaption of the fiber-optic point probe 11 to different applications, the inclination of the planar surface 21 and thus the deflection angle δ can be selected as required, wherein the preceding explanations for the total internal reflection and an optional reflective layer 35 on the backside of the planar surface 21 have to be considered. In order to simplify the manufacturing or the assembly of the fiber-optic point probe 11, a detectable mark 46 can be provided on the additional element 36 connected with the deflection element 20, wherein the mark simplifies the correct alignment of the planar surface 21. For example, the mark 46 can be configured in the additional element 36 as a chamfer, cavity, notch, groove or the like (FIGS. 18 and 19).

In addition or as an alternative to the mark 46 (as illustrated in FIG. 18), a holder 47 can be provided in the additional element 36 for holding an alignment aid, e.g. a pin, or for holding of a tactile probe body having a geometry suitable for the application. In this embodiment the fiber-optic point probe 11 can also be used for tactile probing in addition to the optical distance measurement.

In the embodiments described above the deflection element 20 is configured such that the light is guided inside of the deflection element 20 between the second surface 31 and the spherical end surface 22 and is particularly only deflected by one single reflection on the planar surface 21. In modification to this also multiple reflections can be realized in the deflection element 20 and/or the additional element 36 can be arranged as light-guiding element within the light path.

FIG. 20 shows an embodiment in which the deflection element 20 is configured by a first hemisphere 20a and a second hemisphere 20b that are connected to each other at the planar surface 21. Preferably a reflective layer 35 is provided on the planar surface 21 that is partially reflecting here. The planar surface 21 of deflection element 20 reflects the beam-formed illumination light K not directly to the spherical end surface 22, different to the embodiments described above, but at first partially reflects preferably 50% of the light from the planar surface 21 on a mirroring surface 48 on the second hemisphere 20b. The mirroring surface 48 can be formed by means of a coating of the surface section of the outer surface, particularly the spherical outer surface, of the second hemisphere 20b. The beam-formed illumination light K is thus reflected from the planar surface 21 on the mirroring surface 48 and from there along the second optical axis O2—preferably a portion of 50% thereof—through the planar surface 21 into the respective other, first hemisphere 20a where it exits the spherical end surface 22 realized by a surface section of the first hemisphere 20a.

Further modifications of the deflection element by means of beam splitting are schematically illustrated in FIGS. 21-24. The deflection element 20 is here entirely ball-shaped (FIGS. 22-24) or comprises multiple spherical end surfaces 22, e.g. on separate spherical calottes (FIG. 21). The deflection element 20 can comprise one or multiple planar surfaces 21 that are respectively provided with the reflective layer 35, i.e. configured to be partially reflecting here. In doing so, it is possible to emit multiple illumination beams S in different directions along one or multiple second optical axes O2. In these embodiments the deflection element 20 can be composed of multiple parts.

The above-described embodiments can be combined with each other. For example, in all of the embodiments the different configurations of the beam-forming element 18 as integral GRIN-lens, as integral ball or as multi-part elements having additional reflection surfaces 44 can be provided. The deflection element can also be configured in a single-part or multiple-part manner and preferably comprise at least one hemispherical part or consist from a single hemispherical part.

Also the configuration of the first surface 17 and/or the second surface 31 can be varied in all embodiments and can be particularly configured by a planar surface or a spherical curved surface.

In all of the embodiments the numerical aperture of the illumination beam S is preferably less than 0.3 and for example equal to 0.1.

In order to avoid undesired back-coupling reflections, i.e. reflections in addition to the reference light R into the optical fiber, during the guidance of the illumination light between the optical fiber 12 and the planar surface 21 of the deflection element 20 or in order to at least keep their intensity low compared with the intensity of the measurement light M and the reference light R, one or more of the following explained measures can be realized in all of the embodiments:

1. At locations at which two materials comprise a common optical boundary surface the difference of the refractive indices of the materials is limited to maximum 0.3. Such an optical boundary surface can be formed, for example, on the fiber end 16 of the optical fiber 12 and/or on the second surface 31 of the deflection element 20 and/or on the surfaces of the beam-forming element or of optionally provided spacer elements arranged in the light path of the illumination light B or the beam-formed illumination light K.
2. Surfaces of optical elements arranged in the light path of the illumination light B or the beam-formed illumination light K that adjoin air or an air gap are provided with an anti-reflection coating.
3. The arrangement and the geometry of the light guiding elements inside the light path of the illumination light B or the beam-formed illumination light K are configured such that the wave fronts of the illumination light B or the beam-formed illumination light K are not incident on the optical boundary surfaces in a congruent manner.

In all embodiments the deflection element 20 can consist of a material that has a refractive index of at least or higher than 1.6. As material for the deflection element high-refractive glass or sapphire can be used, for example. However, also fused silica having a refractive index of approximately 1.46 can be used, for example.

In addition, it is possible to provide the spherical end surface 22 in all embodiments with a coating that can be configured as protective coating having a higher hardness relative to the material of the deflection element 20. The coating can in addition or as an alternative form an anti-reflection coating.

The distance measurement system 10 illustrated in FIG. 1 uses the measurement light M reflected on the object surface 26 entering at the spherical end surface 22 into the fiber-optic point probe 11 and coupled into the optical fiber for determination of a distance measurement value with reference to the single reference surface 12b generating the reference light R and arranged in the fiber-optic point probe 11. The light path between the reference surface 12b and the spherical end surface 22 is known, such that the distance d can be determined from the distance measurement value. The evaluation device 28 can thereby operate interferometrically.

The fiber-optic point probe 11 can be adapted in the manner of a modular system very easily to different applications and circumstances without the need to carry out a cumbersome new optic design in connection with a new construction and an optionally new manufacturing technology to be developed, particularly assembly technology, for each application. It can be proceeded as follows:

1. Multiple or all of the following parameters are predefined:
Length of a focus area 23,
Minimum and/or maximum diameter of the focus area (measurement spot size),
Numerical aperture of the illumination beam S emitted on the object surface 26,
Image scale or magnitude in the entire light path of the illumination light B, K, S from the fiber end 16 up to the center point of the focus area 23 outside of the spherical end surface 22,
Emission angle (divergence) of the illumination light B relative to a longitudinal axis of a probe body and/or the first optical axis,
Measurement distance range between the exit surface of the illumination beam S and the object surface 26 to be probed,
Offset and/or number of the required deflection sites (reflection surfaces 44) in order to reach the measurement site on the object surface 26.
   2. The radius of the spherical end surface 22 is determined.
   3. The position of the planar surface 21 relative to the first optical axis O1 and thus also the angle of incidence a is defined such that the position of the second optical axis O2 and the deflection angle δ is obtained.
   4. As an option at least one prismatic part 45 is provided for obtaining at least one additional deflection site in the light path of the illumination light B and the beam-formed illumination light K.
   5. The beam-forming characteristic of the beam-forming element 18 is determined and a suitable beam-forming element is selected, e.g. depending on the radius of the spherical end surface 22.
   6. The diameter of the fiber core 12a of the optical fiber 12 that is known per se and/or the divergence of the illumination light B exiting at the fiber end 16 of the optical fiber 12 is considered.
   7. The length of the light path of the illumination light B between the fiber end 16 and the beam-forming element 18 and optical elements arranged in the light path of the probe are selected depending on a predefined or desired dispersion.
   8. Based thereon the fiber-optic point probe 11 can be configured or assembled from pre-manufactured elements.

The invention refers to a fiber-optic point probe 11 for a distance measurement system 10. The fiber-optic point probe 11 has an optical fiber 12 that can be connected to at least one light source 14, 15 as well as an evaluation device 28. Illumination light B of the light sources 14, 15 is transmitted via the optical fiber 12 to a beam-forming element 18 and is converted into beam-formed illumination light K that is preferably collimated or focused. The beam-formed illumination light K is guided along a first optical axis O1 up to a planar surface 21 of a deflection element 20 and is deflected there by means of reflection. The beam-formed illumination light K reflected on the planar surface 21 spreads along second optical axis O2, exits on a spherical end surface 22 of the deflection element 20 and forms a focused illumination beam S having a focus area 23 outside of the deflection element 20. An object surface 26 arranged in the focus area 23 can be probed such that a distance measurement value relative to a probe internal reference surface 12b can be determined in a contactless manner, wherein the reference surface 12b is configured for partial back reflection of the illumination light B or the beam-formed illumination light K in the form of reference light R. The distance measurement value is characteristic for a distance d between the spherical end surface 22 of the deflection element 20 and the object surface 26. The spherical end surface 22 of the deflection element 20 has a center of curvature that is identical with the point of intersection of the first optical axis O1 and the second optical axis O2.

### REFERENCE SIGNS

5 illumination and evaluation device
6 first Y-fiber coupler
7 second Y-fiber coupler
10 distance measurement system
11 fiber-optic point probe
12 optical fiber
12a fiber core
12b reference surface
13 entry coupling site
14 first light source
15 second light source
16 fiber end
17 first surface
18 beam-forming element
19 spacer element
20 deflection element
20a first hemisphere of deflection element
20b second hemisphere of deflection element
21 planar surface
22 spherical end surface
23 focus area
26 object surface
27 exit coupling site
28 evaluation device
30 third surface
31 second surface
32 probe body
33 probe sleeve
34 adhesive layer
35 reflective layer
36 additional element
37 window
38 outer surface of deflection element
44 reflection surface
45 prismatic part
46 mark
47 holder
48 mirroring surface
α angle of incidence
β angle of reflection
δ deflection angle
B illumination light
d distance
K beam-formed illumination light
M measurement light
n1 first refractive index (of deflection element)
n2 second refractive index (of material or medium adjoining the deflection element)
O1 first optical axis
O2 second optical axis
O3 third optical axis
R reference light
S illumination beam

1. A fiber-optic point probe (11) that is configured for use in a distance measurement system (10), wherein the fiber-optic point probe (11) comprises:
an optical fiber (12) that is configured to couple with at least one monochromatic or narrow band light source (14, 15) at an entry coupling site (13), such that the optical fiber (12) guides illumination light (B) of the at least one light source (14, 15) through a fiber core (12a) of the optical fiber (12) and such that the illumination light (B) at least partly exits from the fiber core (12a) at a fiber end (16) of the optical fiber (12);
a beam-forming element (18) that comprises a first surface (17) and that is configured to beam-form illumination light (B) incident on the first surface (17) and to emit beam-formed illumination light (K) along a first optical axis (01) that is reduced in divergence and/or collimated and/or focused compared with the incident illumination light (B);
exactly one reference surface (12b) that is configured to partly reflect back the illumination light (B) or the beam-formed illumination light (K) as a reference light (R); and
a deflection element (20) that is configured to receive the beam-formed illumination light (K) and that comprises a planar surface (21) orientated obliquely to the first optical axis (O1) that is configured to reflect the received beam-formed illumination light (K) in a direction along a second optical axis (O2) that confines a deflection angle (δ) with the first optical axis (O1), wherein the deflection element (20) comprises a spherical end surface (22) having a center of curvature, wherein the center of curvature is identical to a point of intersection of the first optical axis (O1) and the second optical axis (O2), such that a focused illumination beam (S) exits the spherical end surface (22), wherein a focus area (23) of the focused illumination beam (S) is arranged at a distance with respect to the spherical end surface (22);
wherein the optical fiber (12) is configured to couple with an evaluation device (28) at an exit coupling site (27) such that the reference light (R) and a measurement light (M) formed by reflection and/or scattering in the focus area (23) of the illumination beam (S) at a measurement site on an object surface (26) is received and transmitted to the evaluation device (28) for distance measurement.

2. The fiber-optic point probe according to claim 1, wherein the fiber-optic point probe (11) is configured to arrange the planar surface (21) in one of multiple possible orientations obliquely to the first optical axis (O1) and wherein the orientation of the planar surface (21) leaves other optical characteristics of the fiber-optic point probe (11) unchanged.

3. The fiber-optic point probe according to claim 1, wherein the exactly one reference surface (12b) generating the reference light (R) comprises a shape that is congruent to a wave front of the illumination light (B) or the beam-formed illumination light (K) incident on the exactly one reference surface (12b).

4. The fiber-optic point probe according to claim 3, wherein apart from the exactly one reference surface (12b) all other surfaces in a light path of the illumination light (B) or the beam-formed illumination light (K) incident on the exactly one reference surface (12b) fulfill at least one of the following conditions:
they have a shape that is not congruent to a wave front of the illumination light (B) or the beam-formed illumination light (K) incident on the exactly one reference surface (12b);
they comprise a material having a refractive index, wherein a difference between the refractive index and a refractive index of a directly adjacent material or medium is at most 0.1.

5. The fiber-optic point probe according to claim 1, wherein the exactly one reference surface (12b) generating the reference light (R) is formed by an optical boundary surface at which a refractive index difference of adjoining materials is present and that is free from an anti-reflection coating.

6. The fiber-optic point probe according to claim 1, wherein the exactly one reference surface (12b) generating the reference light (R) is a face of the optical fiber (12) at the fiber end (16) that is oriented orthogonal to the first optical axis (O1, O3) of the illumination light (B).

7. The fiber-optic point probe according to claim 1, further comprising a probe body (32) in or on which an end section of the optical fiber (12) including the fiber end (16), the beam-forming element (18) and the deflection element (20) are arranged in a predefined relative position with respect to one another.

8. The fiber-optic point probe according to claim 7, wherein the probe body (32) comprises a probe sleeve (33), wherein the deflection element (20) is configured to be arranged entirely inside or partly inside of the probe sleeve (33).

9. The fiber-optic point probe according to claim 1, wherein the beam-forming element (18) is an integral component of the deflection element (20).

10. The fiber-optic point probe according to claim 1, wherein the beam-forming element (18) and the deflection element (20) are separate optical elements.

11. The fiber-optic point probe according to claim 10, wherein the deflection element (20) comprises a second surface (31) facing the beam-forming element (18), wherein the second surface (31) is configured for receiving the beam-formed illumination light (K).

12. The fiber-optic point probe according to claim 1, wherein a numerical aperture of the focused illumination beam (S) is less than 0.3.

13. The fiber-optic point probe according to claim 1, wherein the focus area (23) in a direction of the second optical axis (O2) has a length of at most 200 μm.

14. The fiber-optic point probe according to claim 1, wherein at least one spacer element (19) is arranged between the fiber end (16) of the optical fiber (12) and the beam-forming element (18) and/or between the beam-forming element (18) and the deflection element (20).

15. The fiber-optic point probe according to claim 1, wherein at least one air gap is present in a light path between the fiber end (16) of the optical fiber (12) and the beam-forming element (18) and/or between the beam-forming element (18) and the deflection element (20).

16. The fiber-optic point probe according to claim 15, wherein all optical boundary surfaces adjoining the at least one air gap comprise an anti-reflection coating.

17. The fiber-optic point probe according to claim 1, wherein a light path between the fiber end (16) of the optical fiber (12) and the beam-forming element (18) and/or between the beam-forming element (18) and the deflection element (20) is air gap free and apart from a site at which the exactly one reference surface (12b) is located, a refractive index difference of directly adjoining materials and/or media is at most 0.3.

18. The fiber-optic point probe according to claim 1, wherein an optical element (18, 19) arranged directly adjacent to the deflection element (20) comprises a third surface (30) facing a second surface (31) of the deflection element (20), wherein the second surface (31) faces the beam-forming element (18), and wherein the third surface (30) has a concave shape.

19. The fiber-optic point probe according to claim 1, wherein the planar surface (21) of the deflection element (20) is provided with a reflective coating (35) that is partially reflecting or totally reflecting.

20. The fiber-optic point probe according to claim 1, wherein the deflection element (20) is a hemisphere.

21. The fiber-optic point probe according to claim 1, wherein the deflection element (20) comprises a material having a refractive index higher than 1.6 or comprises fused silica.

22. The fiber-optic point probe according to claim 1, wherein an additional element (36) is arranged on the planar surface (21) of the deflection element (20).

23. The fiber-optic point probe according to claim 22, wherein the additional element (36) is a tactile probing element.

24. A distance measurement system (10) comprising a fiber-optic point probe (11) according to claim 1, wherein a monochromatic or narrow band light source (14, 15) is connected with the optical fiber (12) at the entry coupling site (13) and an evaluation device (28) is connected with the optical fiber (12) at the exit coupling site (27) and that is configured to use the reference light (R) reflected back on the exactly one reference surface (12b) of the fiber-optic point probe (11) and the measurement light (M) that is received and coupled into the optical fiber (12) for determination of a distance measurement value between the exactly one reference surface (12b) of the fiber-optic point probe (11) and the measurement site on the object surface (26), wherein the distance measurement value describes a distance (d) between the spherical end surface (22) of the fiber-optic point probe (11) and the measurement site on the object surface (26).
